(19) United States
(12) Patent Application Publication
(10) Pub. No.: US 2015/0016459 A1
(43) Pub. Date: Jan. 15, 2015

(54) METHOD AND APPARATUS FOR FORWARDING PACKET IN IDENTIFIER/LOCATOR SEPARATION ENVIRONMENT

(71) Applicant: Electronics and Telecommunications Research Institute, Daejeon (KR)

(72) Inventors: Tae Ho LEE, Daejeon (KR); Byeongok KWAK, Daejeon (KR); Woojik CHUN, Seoul (KR)

(21) Appl. No.: 14/302,639

(22) Filed: Jun. 12, 2014

(30) Foreign Application Priority Data
Jul. 9, 2013 (KR) 10-2013-0080592

(51) Int. Cl. H04L 12/741

(52) U.S. Cl. CPC H04L 45/745
USPC 370/392

(57) ABSTRACT

A method of a node forwarding a packet in an identifier/locator separation environment is provided. The packet forwarding method includes providing a routing table for storing information on domains, searching the routing table using an identifier (ID) of a domain to which a destination node belongs to obtain first information that is information on a next hop, storing the first information in a forwarding table together with an ID of the destination node, searching the forwarding table using the destination node ID to obtain second information that is information on a next hop, and forwarding the packet using the second information.

### CROSS-REFERENCE TO RELATED APPLICATION

This application claims priority to and the benefit of Korean Patent Application No. 10-2013-0080592 filed in the Korean Intellectual Property Office on Jul. 9, 2013, the entire contents of which are incorporated herein by reference.

### BACKGROUND OF THE INVENTION

1. Field of the Invention

The present invention relates to a method and an apparatus for forwarding a packet in an identifier/locator separation environment.

2. Description of the Related Art

On the Internet, a network processing a packet is referred to as delivery, finding a position of a node (or a station) after the packet is delivered is referred to as forwarding, and routing is required for forwarding. To be specific, routing refers to determining a packet delivery path, from a source node to a destination node, and forwarding refers to moving a packet from an input port of a router to an output port thereof.

Systematically determining a method of delivering a message (a packet) to the destination node using an address on a network is referred to as a path selection process. An apparatus for actively performing the path selection process is referred to as a router, and a database (a list) for selecting a path is referred to as a routing table. The routing table stores information such as a network address of the destination node, exit port information of the router, and metrics for calculating an optimal path. That is, the routing includes a series of operations for generating the routing table required for calculating a path.

Currently, on a network represented by the Internet, there are numerous paths through which a packet may be delivered from a starting point to a destination. The above means that there are many routers through which the packet may be delivered from the starting point to the destination. A routing algorithm is used for selecting one of the many paths. In general, a path through which the packet may be delivered with the smallest cost or quickest delivery is selected through the routing algorithm. The selected path is stored in a forwarding table. That is, in the forwarding table, a port through which the packet is most quickly delivered to the destination is calculated and related information is stored. The router performs the routing algorithm such as a routing information protocol (RIP) and an open shortest path first (OSPF) to calculate the routing table. To be specific, when the router uses a link state algorithm such as OSPF routing, a network topology is established, and the routing table is calculated based on the established network topology. On the other hand, when the router uses a distance/path vector algorithm such as RIP routing, the routing table is calculated without establishing the network topology.

Further, the routing table must be updated in accordance with a change in a network state (for example, disconnections and a change in cost/speed of a specific path).

Currently, due to explosive expansion of the Internet and the appearance of numerous mobile terminals, network traffic is heavily increasing and the routing table is also increased so that expansion of the Internet and management of the routing table are important factors. In addition, due to appearance of various terminals and rapid increase in the number of terminals, since complexity of the network is increased, expandability of the network is a basic requirement. Due to content transmission/reception through numerous personal terminals and data transmission/reception through various kinds of social network services (SNS), network traffic is heavily increasing. Therefore, a method of effectively processing the network traffic is required.

In addition, backbone routing information is rapidly increasing on the Internet. Therefore, measures for processing the routing information of the backbone are urgently required. The routing information is rapidly increasing because non-integrated addresses and contents caused by address allocations to contents, contents requests, movements of terminals multi-homing, and traffic engineering flow to an Internet backbone area. Resultantly, due to the rapid increase in the routing information of the backbone, processes for managing information for communications such as contents addresses and mobile terminal addresses are unnecessarily generated and time for reflecting a corresponding address block or corresponding contents information during a movement of a terminal is increased, which are critical problems.

### SUMMARY OF THE INVENTION

An object of the present invention is to provide a method and an apparatus for forwarding a packet to support expandability of a network and to prevent a forwarding table from being increased in size.

According to an exemplary embodiment of the present invention, a method of a node forwarding a packet in an identifier/locator separation environment is provided. The packet forwarding method includes providing a routing table for storing information on domains, searching the routing table using an identifier (ID) of a domain to which a destination node belongs to obtain first information that is information on a next hop, storing the first information in a forwarding table together with an ID of the destination node, searching the forwarding table using the destination node ID to obtain second information that is information on a next hop, and forwarding the packet using the second information.

The information on domains includes domain IDs for identifying domains, gateway IDs for identifying gateways, gateway addresses corresponding to the gateway IDs, protocol information, and interface information. The gateway IDs, the gateway addresses, the protocol information, and the interface information are used for forwarding a packet to domains corresponding to the domain IDs.

In storing the first information in a forwarding table together with an ID of the destination node, the gateway address, the protocol information, and the interface information in the first information are stored in the forwarding table together with the destination node ID.

The packet forwarding method may further include receiving an ID of a domain to which the destination node belongs from a previous node before providing a routing table for storing information on domains.

Obtaining the first information includes searching the routing table using a longest prefix match (LPM) algorithm for the ID of the domain to which the destination node belongs.

Obtaining the second information includes searching the forwarding table using an exact matching algorithm for the destination node ID. In addition, according to another exemplary embodiment of the present invention, an apparatus for forwarding a packet in an identifier/locator separation environment is provided. The packet forwarding apparatus includes a routing table managing processor including a routing table for storing information on domains to search the routing table using an ID of a domain to which a to destination node belongs and to output first information that is searched information on a next hop, a forwarding table managing processor including a forwarding table for storing packet delivery paths to store the first information in the forwarding table together with an ID of the destination node, to search the forwarding table using the destination node ID, and to output second information that is searched information on a next hop, and a forwarding processor for forwarding a packet using the second information.

In addition, according to still another exemplary embodiment of the present invention, a packet forwarding method for a first node delivering a packet to a second node in an identifier/locator separation environment is provided. The packet forwarding method includes finding a first domain ID that is an ID of a domain to which the second node belongs, searching a routing table for storing information on domains using the first domain ID to obtain first information that is information on a next hop, storing the first information in a forwarding table together with a first node ID that is an ID of the second node, searching the forwarding table using the first node ID to obtain second information that is information on a next hop, and forwarding the packet using the second information.

### BRIEF DESCRIPTION OF THE DRAWINGS

FIG. 1 is a view illustrating a routing table according to an exemplary embodiment of the present invention.

FIG. 2 is a view illustrating a forwarding table according to an exemplary embodiment of the present invention.

FIG. 3 is a flowchart illustrating processes for searching a packet delivery path according to an exemplary embodiment of the present invention.

FIG. 4 is a view illustrating an example for describing path searching processes of FIG. 3.

FIG. 5A is a view illustrating an example of a routing table and a forwarding table that a source node has according to an example of FIG. 4.

FIG. 5B is a view illustrating an example of a routing table and a forwarding table that a router has according to an example of FIG. 4.

FIG. 5C is a view illustrating an example of a routing table and a forwarding table that a node has according to an example of FIG. 4.

FIG. 6 is a view illustrating a packet forwarding apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A method of a forwarding system according to an exemplary embodiment of the present invention for forwarding a packet includes establishing a global topology database based on link state information in an identifier/locator separation environment, establishing a routing table based on the global topology database, establishing a forwarding table based on the routing table, forwarding a packet in accordance with the forwarding table, and managing a forwarding table that is not used for a period of time.

In establishing the global topology database, a global topology database for an entire network is established based on link state information like a routing protocol such as open shortest path first (OSPF). To be specific, when the global topology database is established, a fish-eye topology reduction technique is applied. By applying the fish-eye topology reduction technique, a size of a global topology graph may be remarkably reduced so that an amount of data of the global topology database may be reduced. Therefore, expandability of the routing protocol may be supported.

When the routing table is established when establishing the routing table, address information (a domain ID having a locator function) on a specific destination domain is stored in the routing table. Here, a domain refers to a region configured by at least one network node. The routing table does not store routing information of all destination nodes. When communication with a specific destination node is generated, the forwarding system finds a packet delivery path by searching the routing table and stores searched information in a forwarding cache (a forwarding table). Therefore, since the forwarding table is generated based on the routing table only when the communication with the specific destination node is generated, unnecessary packet delivery path information items are not previously stored.

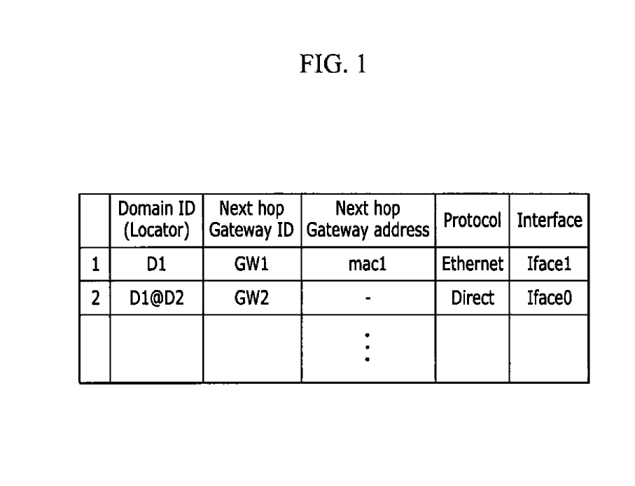

FIG. 1 is a view illustrating a routing table according to an exemplary embodiment of the present invention.

As illustrated in FIG. 1, the routing table does not manage information on a specific destination node but only has information on domains. Therefore, routing according to the present invention involves finding an identifier (ID) of a domain to which the specific destination node belongs, and searching the routing table based on the found domain ID to set up a packet delivery path to the destination node.

The routing table uses a domain ID having a locator function as a table key, and stores next hop information for delivering a packet to a domain corresponding to a specific domain ID. To be specific, the next hop information includes a next hop gateway ID, a next hop gateway address, protocol information used for a section to a next hop, and an egress interface for delivering a packet to the next hop. For example, in order for a node (for example, a router) to deliver a packet to a domain D1, a gateway GW1 having a MAC address mac1 must be used, and an Iface1 interface and an Ethernet protocol must be used. On the other hand, in order for the node to deliver the packet to a domain D1@D2, a gateway GW2 that is physically directly connected to an Iface0 interface must be used. Here, the domain D1@D2 means a domain D2 that belongs to a domain D1.

In searching the routing table, a longest prefix match (LPM) algorithm for a locator is used like in conventional IP routing. For example, when a locator to be searched is a domain ID D1@D2@D3, an LPM result for a domain ID D1 that is a first article of the routing table of FIG. 1 is 1 and an LPM result for a domain identifier D1@D2 that is a second article is 2. Here, the domain ID D1@D2 having the largest LPM result is selected.

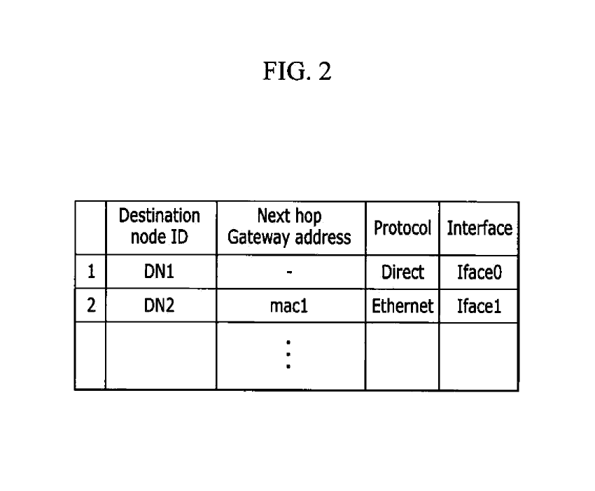

FIG. 2 is a view illustrating a forwarding table according to an exemplary embodiment of the present invention.

A node searches a suitable article from the routing table of FIG. 1 to store the searched information in a forwarding table. The forwarding table stores delivery paths for delivering a packet to a destination node based on information on a destination node ID, unlike the routing table.

The forwarding table uses the destination node ID as a table key and stores information on which delivery path is to be used for delivering the packet to the destination node corresponding to the destination node ID. To be specific, in the forwarding table, the information on the delivery path is expressed as a next hop gateway address and protocol information and interface information used for delivering the packet to a next hop. For example, in order for a node to deliver a packet to a destination node DN1, the node must forward the packet using the Iface0 interface that is physically directly connected to a next hop gateway. On the other hand, in order for the node to deliver the packet to a destination node DN2, the node must forward the packet to a node having the MAC address mac1 through the Iface1 interface. Further, in searching the forwarding table, unlike when searching the routing table, an exact matching algorithm for a destination node ID is used. Here, the exact matching algorithm means an algorithm for finding the same node ID as the destination node ID to be searched in the forwarding table. Therefore, a speed at which the forwarding table is searched may be improved.

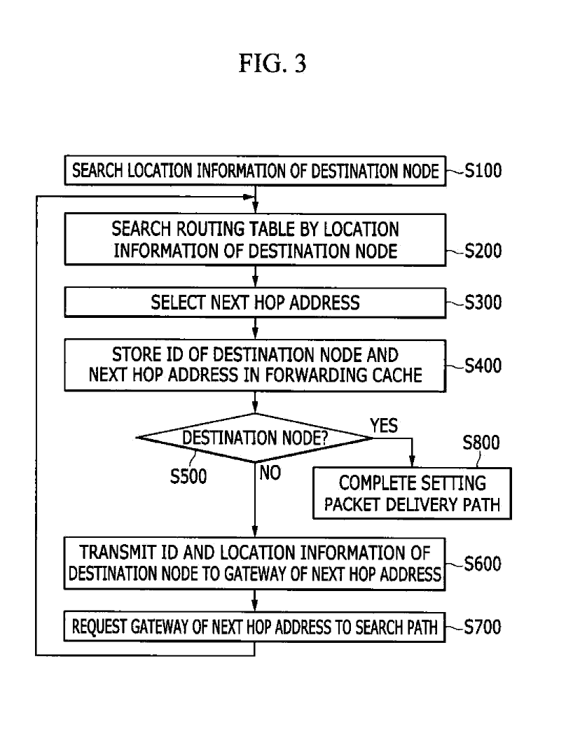

FIG. 3 is a flowchart illustrating processes for searching a packet delivery path according to an exemplary embodiment of the present invention. Path searching processes based on an ID-based communication will be described with reference to FIG. 3. A source node starts from S100 and a node after the source node to a destination node starts from S200.

A node searches location information of the destination node (S100). The location information is a domain ID and has a locator function that represents where the destination node is. On the other hand, S100 is performed by the source node.

The node searches a routing table using the location information obtained in S100 (S200). In searching the routing table, an LPM algorithm for comparing the location information obtained in S100 and a table key (i.e., a domain ID) of the routing table with each other is used. The node selects a domain ID having the largest LPM result value (S300).

The node inputs information on an article selected in S300 to a forwarding cache together with a destination node ID (S400). Therefore, the forwarding illustrated in FIG. 2 is generated.

The node determines whether it is a destination node of a packet (S500). When it is determined that the node is the destination node of the packet, processes of setting up a packet delivery path are completed (S800). Packets sent toward the same destination node are delivered through the packet delivery path generated in the forwarding table.

On the other hand, when the node is not the destination node of the packet, the destination node ID and the location information (a locator) obtained in S100 are delivered to a next hop gateway (S600). Then, the node requests the next hop gateway to search a path to the destination node (S700).

The next hop gateway repeats S200 to S700. The above processes (S200 to S700) are repeated until the packet is delivered to the destination node.

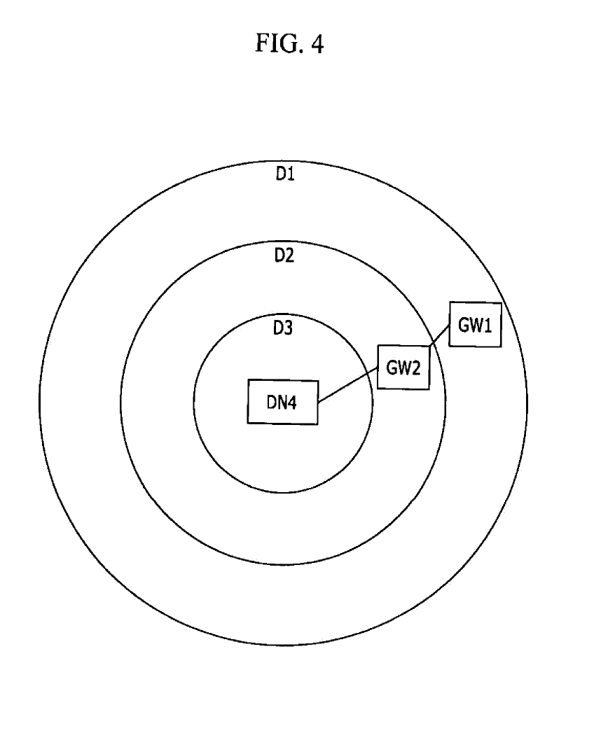

FIG. 4 is a view illustrating an example for describing the path searching processes of FIG. 3. The path searching processes of FIG. 3 will be described again with reference to FIG. 4. In FIG. 4, for convenience sake, the source node belongs to the domain D1, the domain D1 includes the gateway GW1, and the domain D2 includes the gateway GW2. A node may configure one domain and may be operated by a gateway of the domain. In FIG. 4, a destination node DN4 configures one domain D3 and is operated by a gateway of the domain D3. Further, it is assumed that the domains D1, D2, and D3 of FIG. 4 are different from the above-described domains D1, D2, and D3 of FIG. 1. It is also assumed that the gateways GW1 and GW2 of FIG. 4 are different from the gateways GW1 and GW2 of FIG. 1. A case in which the source node delivers the packet to the destination node DN4 will be described as an example.

The source node searches location information of the destination node DN4 (S100). For convenience sake, it is assumed that the location information of the searched destination node DN4 is a domain ID D1@D2@D3.

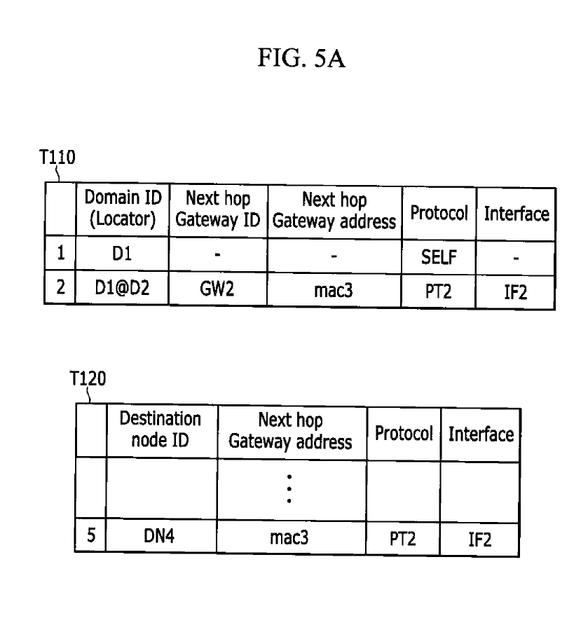

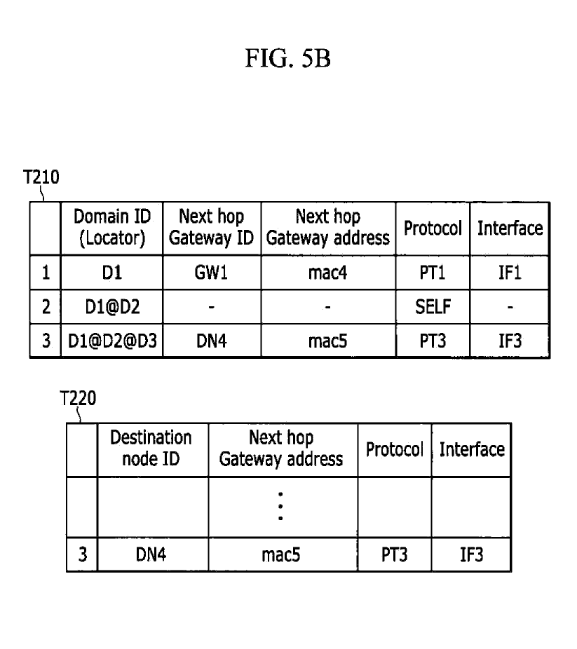

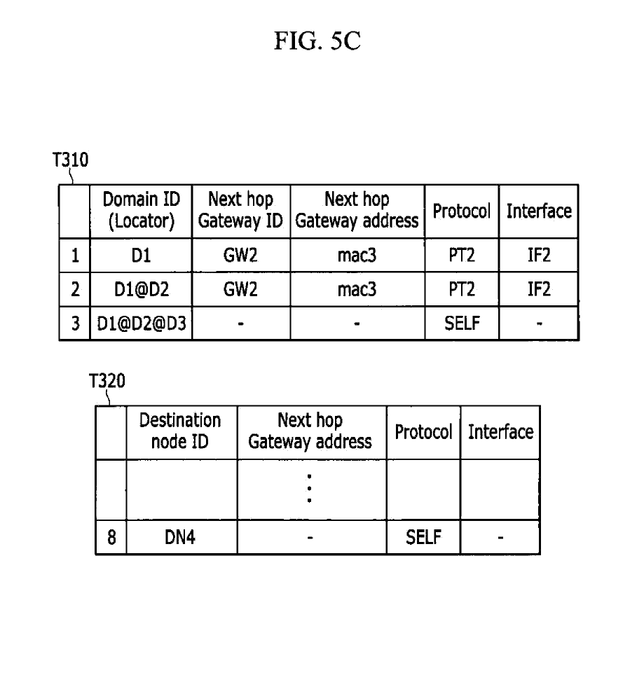

The source node searches the routing table using the location information Dl@D2@D3 obtained in S100 (S200). For convenience sake, it is assumed that the routing table that the source node has is a routing table T110 illustrated in FIG. 5A. The source node compares the location information D1@D2@D3 obtained using the LPM algorithm in S100 and a domain ID of the routing table T110 with each other. An LPM result value for a domain ID D1 that is a first article of the routing table T110 is 1 and an LPM result value for a domain ID D1@D2 that is a second article is 2. The source node selects the domain ID D1 @D2 having the largest LPM result value (S300).

The source node stores information on the article D1@D2 selected in S300, that is, a next hop gateway address mac3, protocol information PT2, and interface information IF2 in the forwarding table together with the destination node ID DN4 (S400). Therefore, the forwarding table that the source node has may be a forwarding table T120 illustrated in FIG. 5A.

Since the source node is not the destination node of the packet, the destination node ID DN4 and the location information D1@D2@D3 obtained in S100 are delivered to a next hop gateway GW2 having the MAC address mac3 (S600). Then, the node requests the next hop gateway GW2 to search a path to the destination node DN4 (S700). When the source node forwards the packet to the next hop gateway GW2, the PT2 protocol and the IF2 interface are used.

Since the next hop gateway GW2 that belongs to the domain D2 is not the destination node of the packet, S200 to S700 are repeated.

To be specific, the gateway GW2 searches the routing table using the location information of the destination node delivered from the source node (S200). For convenience sake, it is assumed that the routing table that the gateway GW2 has is a routing table T210 illustrated in FIG. 5B. The gateway GW2 compares the location information D1@D2@D3 and a domain ID of the routing table T210 with each other using the LPM algorithm. An LPM result value of a domain ID D1 that is a first article of the routing table T210 is 1, an LPM result value for a domain ID D1@D2 that is a second article is 2, and an LPM result value for the domain ID D1@D2@D3 that is a third article is 3. The gateway GW2 selects the domain ID D1@D2@D3 having the largest LPM result value (S300).

The gateway GW2 stores information on the article D1@D2@D3 selected in S300, that is, a next hop gateway address mac5, protocol information PT3, and interface information IF3 in the forwarding table together with the destination node ID DN4 (S400). Therefore, the forwarding table that the gateway GW2 has may be a forwarding table T220 illustrated in FIG. 5B.

Since the gateway GW2 is not the destination node of the packet, the destination node ID DN4 and the location information D1@D2@D3 of the destination node are delivered to a next hop gateway DN4 having the MAC address mac5 ($600). Then, the gateway GW2 requests the next hop gateway DN4 to search a path to the destination node DN4 (S700). When the gateway GW2 forwards the packet to the next hop gateway DN4, the PT3 protocol and the IF3 interface are used.

The gateway DN4 searches the routing table using the location information D1 ©D2©D3 of the destination node delivered from the gateway GW2 (S200). For convenience sake, it is assumed that the routing table that the gateway DN4 has is a routing table T310 illustrated in FIG. 5C. The gateway DN4 compares the location information D1©D2©D3 and a domain ID of the routing table T310 with each other using the LPM algorithm. An LPM result value for a domain ID D1 that is a first article of the routing table T310 is 1, an LPM result value for a domain ID D1 @D2 that is a second article is 2, and an LPM result value for a domain ID D1 ©D2©D3 that is a third article is 3. The gateway DN4 selects the domain ID D1©.D2©D3 having the largest LPM result value (S300).

The gateway DN4 stores the information on the article D1 ©D2©D3 selected in S300 in the forwarding table together with the destination node ID DN4 (S400). Therefore, the forwarding table that the gateway DN4 has may be a forwarding table T320 illustrated in FIG. 5C.

Since the gateway DN4 is the destination node DN4 of the packet, processes of setting up the packet delivery path are completed (S800).

Packets sent toward the same destination node DN4 are delivered through packet delivery paths generated in the forwarding tables 1120, T220, and T320. In searching the forwarding tables T120, T220, and T320, an exact matching algorithm for the destination node ID DN4 is used.

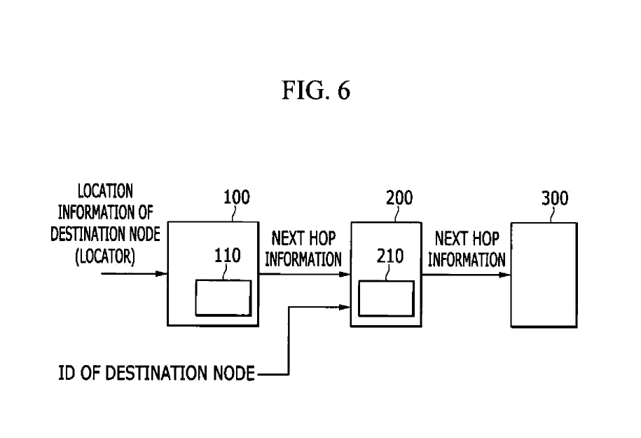

FIG. 6 is a view illustrating a packet forwarding apparatus according to an exemplary embodiment of the present invention.

The packet forwarding apparatus of FIG. 6 performs the above-described packet forwarding method in the identifier/locator separation environment.

The packet forwarding apparatus may include a routing table managing processor 100, a forwarding table managing processor 200, and a forwarding processor 300.

The routing table managing processor 100 includes a routing table 110 for storing information on domains. The routing table 110 may be configured in the same way as the above-described routing table of FIG. 1. To be specific, the routing table managing processor 100 searches the routing table 110 by location information (an ID of a domain to which, a destination node belongs, for example, D1@D2@D3) of the destination node (for example, DN4) to output information on a next hop (for example, a next hop gateway address, protocol information, and interface information). On the other hand, the routing table managing processor 100 uses the LPM algorithm for the location information of the destination node in searching the routing table 110.

The forwarding table managing processor 200 includes a forwarding table 210 for storing packet delivery paths. The forwarding table 210 may be configured in the same way as the above-described forwarding table of FIG. 2. To be specific, the forwarding table managing processor 200 stores the information on the next hop output from the routing table managing processor 100 in the forwarding table 210 together with the destination node ID (for example, DN4). The forwarding table managing processor 200 searches the forwarding table 210 by the destination node ID (for example, DN4) to output the searched information on the next hop (for example, the next hop gateway address, the protocol information, and the interface information). On the other hand, the forwarding table managing processor 200 uses the exact matching algorithm for the destination node ID (for example, DN4) in searching the forwarding table 210.

The forwarding processor 300 forwards a packet using the information on the next hop output from the forwarding table managing processor 200.

According to an exemplary embodiment of the present invention, it is possible to prevent the size of a routing table and a forwarding table from being increased through ID-based communication.

In addition, according to an exemplary embodiment of the present invention, it is possible to prevent performance of a system from being deteriorated by an increase in size of the forwarding table.

Further, according to an exemplary embodiment of the present invention, when the forwarding table is searched in order to find a packet delivery path, rather than a longest prefix match (LPM) algorithm of conventional IP routing, an exact matching algorithm is used with merits (for example, reduction in search time) of exact matching.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a node forwarding a packet in an identifier/locator separation environment, the method comprising:
providing a routing table for storing information on domains;
searching the routing table using an identifier (ID) of a domain to which a destination node belongs to obtain first information that is information on a next hop;
storing the first information in a forwarding table together with an ID of the destination node;
searching the forwarding table using the destination node ID to obtain second information that is information on a next hop; and
forwarding the packet using the second information.

2. The packet forwarding method of claim 1, wherein the information on domains comprises domain IDs for identifying domains, gateway IDs for identifying gateways, gateway addresses corresponding to the gateway IDs, protocol information, and interface information, wherein the gateway IDs, the gateway addresses, the protocol information, and the interface information are used for forwarding a packet to domains corresponding to the domain IDs.

3. The packet forwarding method of claim 2, wherein, in storing the first information in a forwarding table together with an ID of the destination node, the gateway address, the protocol information, and the interface information in the first information are stored in the forwarding table together with the destination node ID.

4. The packet forwarding method of claim 1, further comprising receiving an ID of a domain to which the destination node belongs from a previous node before providing a routing table for storing information on domains.

5. The packet forwarding method of claim 1, wherein obtaining the first information comprises searching the routing table using a longest prefix match (LPM) algorithm for the ID of the domain to which the destination node belongs.

6. The packet forwarding method of claim 1, wherein obtaining the second information comprises searching the forwarding table using an exact matching algorithm for the destination node ID.

7. An apparatus for forwarding a packet in an identifier/locator separation environment, the apparatus comprising:
a routing table managing processor including a routing table for storing information on domains, searching the routing table using an ID of a domain to which a destination node belongs, and outputting first information that is searched information on a next hop;
a forwarding table managing processor including a forwarding table for storing packet delivery paths, storing the first information in the forwarding table together with an ID of the destination node, searching the forwarding table using the destination node ID, and outputting second information that is searched information on a next hop; and
a forwarding processor for forwarding a packet using the second information.

8. The packet forwarding apparatus of claim 7, wherein the routing table stores domain IDs for identifying domains, gateway IDs for identifying gateways, gateway addresses corresponding to the gateway IDs, protocol information, and interface information, wherein the gateway IDs, the gateway addresses, the protocol information, and the interface information are used for forwarding a packet to domains corresponding to the domain IDs.

9. The packet forwarding apparatus of claim 8, wherein the forwarding table managing processor stores the gateway address, the protocol information, and the interface information of the first information in the forwarding table together with the destination node ID.

10. The packet forwarding apparatus of claim 7, wherein the routing table managing processor uses an LPM algorithm for the 1D of the domain to which the destination node belongs in searching the routing table.

11. The packet forwarding apparatus of claim 7, wherein the forwarding table managing processor uses an exact matching algorithm for the destination node ID in searching the forwarding table.

12. The packet forwarding apparatus of claim 7, wherein the routing table managing processor receives the ID of the domain to which the destination node belongs from a previous node.

13. A packet forwarding method for a first node delivering a packet to a second node in an identifier/locator separation environment, comprising:
finding a first domain ID that is an ID of a domain to which the second node belongs;
searching a routing table for storing information on domains using the first domain ID to obtain first information that is information on a next hop;
storing the first information in a forwarding table together with a first node ID that is an ID of the second node;
searching the forwarding table using the first node ID to obtain second information that is information on a next hop; and
forwarding the packet using the second information.

14. The packet forwarding method of claim 13, wherein obtaining the first information comprises searching the routing table using an LPM algorithm for the first domain ID.

15. The packet forwarding method of claim 13, wherein obtaining the second information comprises searching the forwarding table using an exact matching algorithm for the first node ID.
